(19) United States
(12) Patent Application Publication
(10) Pub. No.: US 2020/0310360 A1
(43) Pub. Date: Oct. 1, 2020

(54) ELECTRONIC TIMEPIECE AND NOTIFICATION CONTROL METHOD

(71) Applicant: CASIO COMPUTER CO., LTD., Tokyo (JP)

(72) Inventor: Kosuke HASEGAWA, Tokyo (JP)

(73) Assignee: CASIO COMPUTER CO., LTD., Tokyo (JP)

(21) Appl. No.: 16/835,909

(22) Filed: Mar. 31, 2020

(30) Foreign Application Priority Data
Apr. 1, 2019 (JP) 2019-069635

(51) Int. Cl. G04G 9/00; G04G 21/04; H04M 1/725

(52) U.S. Cl. CPC G04G 9/007; G04G 21/04; H04M 1/72547; H04M 1/7253; H04M 1/72583

(57) ABSTRACT

An electronic timepiece includes a display, a communicator, and a processor. The communicator communicates with an external device. The processor causes the display to display, as multiple kinds of information obtained by the communicator from the external device, an icon corresponding to a category to which each of the multiple kinds of information belongs.

### CROSS-REFERENCE TO RELATED APPLICATIONS

This application is based upon and claims the benefit of priority from the prior Japanese Patent Application No. 2019-069635, filed on Apr. 1, 2019, the entire contents of which are incorporated herein by reference.

### BACKGROUND

### Technical Field

The present disclosure relates to an electronic timepiece and a notification control method.

### Background Art

There is a technique to cause an electronic device, more specifically a portable electronic device such as a smartphone, to notify a user of events and schedules having been set relating to application programs (applications, software). Contents of the events include reception of calls, voice mails, SMS (short message service), instant messages, emails and news, occurrence of events relating to games and so forth, and notification of the date and time of schedules having been set. On notification, sources (e.g., applications) and contents (senders/originators of the notifications and/or part of texts of the events) of the events are displayed as a list on a display screen, and the user can obtain more detailed contents by making a selection operation (for example, disclosed in JP 2014-197401A).

There is also a technique to cause an electronic device to send information on occurrence of the events to a mobile device different from the electronic device, more specifically a wearable terminal such as a watch, and cause the mobile device to inform a user of the occurrence of the events. Many recent mobile devices employ near-field wireless communication technologies with low power consumption, such as Bluetooth Low Energy (BLE) being included in Bluetooth® since version 4.0. The electronic device as a server (notification provider) sends the abovementioned notifications through BLE with Alert Notification Profile (ANP) and/or Apple Notification Control Center (ANCS) profile, which is unique to iOS, in accordance with Generic Attribute Profile (GATT).

### SUMMARY

An electronic timepiece according to an embodiment includes a display; a communicator that communicates with an external device; and a processor that causes the display to display, as multiple kinds of information obtained by the communicator from the external device, an icon corresponding to a category to which each of the multiple kinds of information belongs.

### BRIEF DESCRIPTION OF THE DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a front view of an electronic timepiece;

FIG. 2 is a block diagram showing functional configuration of the electronic timepiece;

FIG. 3A is an example of a content displayed on a display screen of the electronic timepiece;

FIG. 3B is an example of a content displayed on the display screen of the electronic timepiece; and

FIG. 4 is a flowchart showing control procedure of a notification display control process in the electronic timepiece.

### DESCRIPTION OF EMBODIMENTS

Hereinafter, one or more embodiments is described in detail with reference to the drawings. However, the present invention is not limited to the illustrated examples.

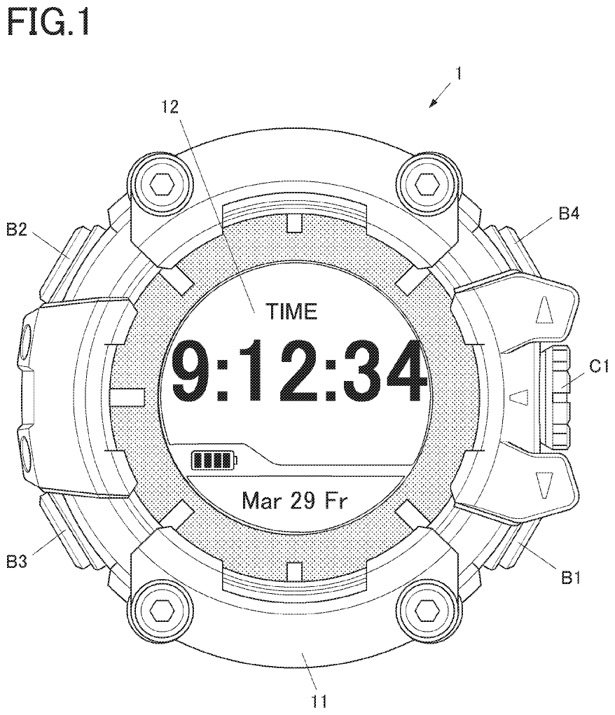

FIG. 1 is a front view of an electronic timepiece 1 in this embodiment.

The electronic timepiece 1 includes a casing 11, a display screen 12, push-button switches B1 to B4, and a crown C1. The display screen 12 may be covered with a windproof crystal or the like.

The casing 11 has, for example, a tubular form both ends of which are open. One open end is provided with the display screen 12, and the other is sealed with a not-shown cover. In the casing 11, a substrate(s), a chip(s), and electronic parts configured to perform various operations, a battery, and so forth are provided between the display screen 12 and the cover.

The display screen 12 performs dot-matrix digital display. In this embodiment, the display screen 12 can display numbers and symbols relating to current time, various characters, a diagram showing the charged state of the battery, and so forth. The setting of the font, position, or the like of each displayed content may be changed. The number of characters that can be displayed at one time depends on the font size. With a standard font size, approximately 100 characters can be displayed.

The push-button switches B1 to B4 and the crown C1 stick out through the casing 11, in which the above-described components are provided, and can receive operations performed outside, for example, performed by a user. The push-button switches B1 to B4 each output an electronic signal as an input signal in response to a pushing operation. The crown C1 outputs an electronic signal as an input signal in response to a pulling operation, a pushing operation, and a turning operation.

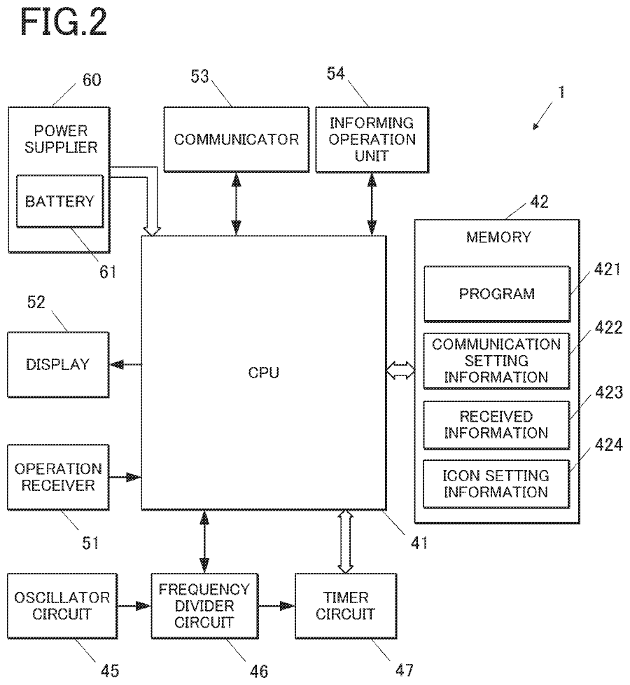

FIG. 2 is a block diagram showing functional configuration of the electronic timepiece 1.

The electronic timepiece 1 includes a Central Processing Unit (CPU) 41 (processor), a memory 42, an oscillator circuit 45, a frequency divider circuit 46, a timer circuit 47 (time counter), an operation receiver 51, a display 52, a communicator 53, an informing operation unit 54, and a power supplier 60.

The CPU 41 is a processor that performs various arithmetic processes and integrally controls operation of each component of the electronic timepiece 1. The CPU 41 reads and executes programs 421 stored in the memory 42, thereby performing various control operations. In accordance with contents of operations received by the operation receiver 51, the CPU 41 can switch contents displayed on the display screen 12 and cause the display screen 12 to display information received by the communicator 53.

The memory 42 provides the CPU 41 a working memory space and stores various data. The memory 42 includes a Random Access Memory (RAM) and a nonvolatile memory. The RAM is used for arithmetic processes performed by the CPU 41 and stores temporary data. The nonvolatile memory is, for example, a flash memory, and stores various settings, the programs 421, and so forth.

The memory 42 also stores communication setting information 422, received information 423, and icon setting information 424. The communication setting information 422 includes identification information of an external device(s) that is connected to the electronic timepiece 1 through paring in Bluetooth communication. The received information 423 includes data that the communicator 53 receives from the external device. The icon setting information 424 includes image data and settings of icons (correspondence between categories and icons) to be used in displaying a list of notification information, which is described later. A basic program and initial setting data, which are not usually updated, of the electronic timepiece 1 may be stored in a Read only Memory (ROM).

The oscillator circuit 45 generates a clock signal(s) having a predetermined frequency of oscillation, for example, 32.768 kHz, and outputs the clock signal to the frequency divider circuit 46. The frequency divider circuit 46 divides the frequency of the clock signal, thereby converting the frequency into a frequency required for operation of each component of the electronic timepiece 1, and outputs the clock signal having the divided frequency to the timer circuit 47 and so forth.

The timer circuit 47 counts and maintains current time by counting the signal having a predetermined frequency, the signal having been input by the frequency divider circuit 46. The format of the date and time maintained by the timer circuit 47 is not limited to the format in which date, time, minute, and second are shown, but may be a format appropriate and suitable for processes performed by the CPU 41. The frequency of oscillation generated by the oscillator circuit 45 slightly changes depending on the external environment such as temperature. Accordingly, under the normal environment, the date and time counted by the timer circuit 47 could deviate by approximately 0.5 second per day. The electronic timepiece 1 may be configured to obtain the correct date and time from outside through the communicator 53 and/or a not-shown radio wave receiver and correct the deviation in the date and time counted by the timer circuit 47.

The operation receiver 51 receives input operations performed outside (e.g. performed by a user) and outputs input signals to the CPU 41. The operation receiver 51 in this embodiment includes the above-described push-button switches B1 to B4 and the crown C1. The operation receiver may further include a touchscreen superposed on the display screen 12 of the display 52.

The display 52 performs display operation under the control of the CPU 41. The display 52 performs digital display on the display screen 12. The display screen 12 in this embodiment can perform dot-matrix display and is, for example, a liquid crystal display screen or an organic electroluminescence display screen.

The communicator 53 performs and controls data exchange (communication) with the external device. The communicator 53 in this embodiment can perform Low Energy communication through Bluetooth version 4 and higher versions (hereinafter called BLE communication).

The informing operation unit 54 performs predetermined informing operations for the user under the control of the CPU 41. Examples of the informing operations include generating beeps and vibrations. The informing operation unit 54 includes a beep generation mechanism for generating well-known beeps and/or a vibration generation mechanism.

The power supplier 60 supplies electronic power to each component of the electronic timepiece 1 from the battery 61 with a predetermined operation voltage. The electronic power may be supplied indirectly through the CPU 41 or the like. The battery 61 includes, for example, a solar panel and a storage battery. The battery 61 may be a detachable dry cell battery, button battery, or the like. The power supplier 60 may alternatively include, as the battery 61, a secondary battery such as a lithium-ion battery that is charged by being connected to a cable or a connecting terminal or by being combined electromagnetically.

Next, display operation in this embodiment is described.

The electronic timepiece 1 can communicate with an external device (smartphone) through BLE, obtain multiple kinds of information from the smartphone, and notifies a user of each of the multiple kinds of information obtained. The multiple kinds of information include: information on reception of incoming calls, incoming emails, incoming messages through communications including short messages, instant messages, and messages through Social Networking Service (SNS) received by the smartphone, reception of distributed news, reception of information predetermined on various application programs (hereinafter called applications) including various services such as online flea markets or games, and arrival of the scheduled time set in the smartphone. The multiple kinds of notification information are displayed by a predetermined number as a list, which may be scrolled. When the user selects desired information from the list, the electronic timepiece 1 displays more detailed content of the selected information.

Contents of the notifications may include multiple senders. With respect to some of the notifications such as the notification of emails, information on senders and so forth may be easily extracted on the basis of standard header information or the like. However, applications of SNS including instant messages, applications of news, or the like exchange information in versatile data formats such as JavaScript Object Notation (JSON) or Extensible Markup language (XML) in accordance with Hyper Text Transfer Protocol (HTTP) or other unique protocols. Because each of the applications determines its data exchange format according to Application Programming Interface (API), required information may not always be extracted uniformly. Thus, the electronic timepiece 1 may not always extract, from information received through BLE communication, an optimum content to display in the list of notification information.

Further, many new applications and services, especially for SNS, emerge and disappear one after another. The electronic timepiece 1 is normally used for a long period of time, and its control program is not supposed to be updated. Hence, the electronic timepiece 1 may not obtain and retain new services (application names) and the corresponding icons beforehand.

The electronic timepiece 1 in this embodiment obtains information on categories to which the application services belong from the contents (information) sent to the electronic timepiece 1 from the smartphone in accordance with the ANP and/or the ANCS, and displays icons for the obtained categories at the top of the respective display items. Thus, the electronic timepiece 1 displays, without increasing processing time and load, the multiple kinds of notification information in such a way as to allow the user to appropriately and easily grasp minimal necessary contents of the multiple kinds of notification information. The contents (information) sent from the smartphone to the electronic timepiece 1 in accordance with ANP and/or ANCS include category IDs indicating the categories.

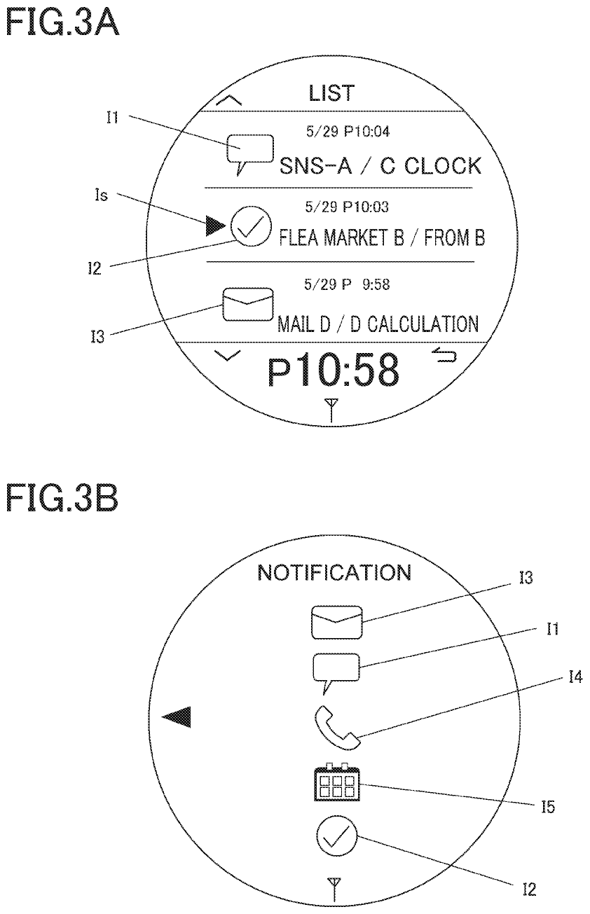

FIGS. 3A and 3B are diagrams showing examples of display on the display screen 12 of the electronic timepiece 1. FIG. 3A exemplifies a list of notification information displayed. In this embodiment, three pieces of (multiple kinds of) notification information are displayed as the list on one display screen. The list can be scrolled back and forth (up and down) by, for example, turning operations on the crown C1 or pushing operations on the push-button switches B2, B3. Each item in the displayed list includes an icon corresponding to the category to which the information as a display target belongs, the date and time when the information is obtained by the smartphone, and a portion(s) of the content of the information including sender information. A cursor icon Is is displayed on the left to the second notification information shown at the center of the display screen, thereby pointing the second notification information. In response to a predetermined selection operation such as pushing the push-button switch B4, the electronic timepiece 1 displays more detailed content of the second notification information being pointed by the cursor icon Is. The number of characters consisting a detailed content to be displayed may be between 100, which can be displayed on one display screen, and around 400, which can be displayed with some scrolls.

In the upper row in FIG. 3A, an icon I1 relating to message communication and portions extracted from the content are shown side by side. The portions extracted in this embodiment are the first few characters of first and second parts, the first part being preset as a part that tends to correspond to the application name and the second part being preset as a part that tends to correspond to the name of a sender or a content (text). The parts to be extracted may be set for each category and stored in the icon setting information 424.

In the middle row, an icon I2 (miscellaneous icon) for miscellaneous categories is shown. The miscellaneous categories are the categories other than the categories for which icons have been set. For the miscellaneous categories, a first part (herein, for example, application name) and a second part (herein, for example, text) are extracted from the notification information and shown next to the icon I2. In the lower row, an icon I3 relating to emails is shown. For the category of emails, a first part (herein, for example, sender of email) and a second part (herein, for example, subject of email) are extracted and shown next to the icon I3. In FIG. 3A, the application name or the corporation name as the sender is shown as examples of the first parts. There may be a case where the electronic timepiece 1 cannot obtain a correct name to display.

FIG. 3B exemplifies display of a list of icons set to be displayable.

As described above, the category IDs determined in GATT and/or ANCS are used as the categories. In this embodiment, among the category IDs, “Incoming Call” (a bit value corresponding to “Incoming Call”, the same applies hereinafter) indicating incoming calls, “Missed Call” indicating missed calls, “Voice Mail” indicating reception of voice mails including messages on answering machines, and so forth can be altogether associated with a phone icon I4. “SMS/MMS” indicating reception of short messages, “Instant Message” (GATT) indicating reception of instant messages, and “Social” (ANCS) indicating both “SMS/MMS” and “Instant Message” are associated with the icon I1 relating to messages through communications. Herein, SNS messages through communications are included in any of “SMS/MMS”, “Instant Message”, or “Social”. “Schedule” indicating schedule setting is associated with a schedule-table icon I5. “Email” indicating reception of emails is associated with the mail icon I3. Any other category IDs (categories) not associated with any of the above icons as the display target, such as “News” and notifications on the abovementioned flea market applications, game applications, are associated with the miscellaneous icon I2. The icon setting information 424 includes (i.e., the memory 42 stores) data in which the above icons I1 to I5 are associated with the category IDs (categories).

The setting of the correspondence between the icons and the category IDs may be changeable. For example, “News” may be associated with an individual icon. The category IDs that are determined in ANCS alone, such as “Location”, may be associated with an individual icon by the user. “Voice mail” and reception of SNS messages may be shown by the icon I3 relating to emails. The setting of the correspondence between the icons and the category IDs may be changed in accordance with a setting instruction from outside, such as input operations performed by the user on the operation receiver 51. Alternatively, the electronic timepiece 1 may obtain data that has been set with and sent from the external device (smartphone) through the communicator 53.

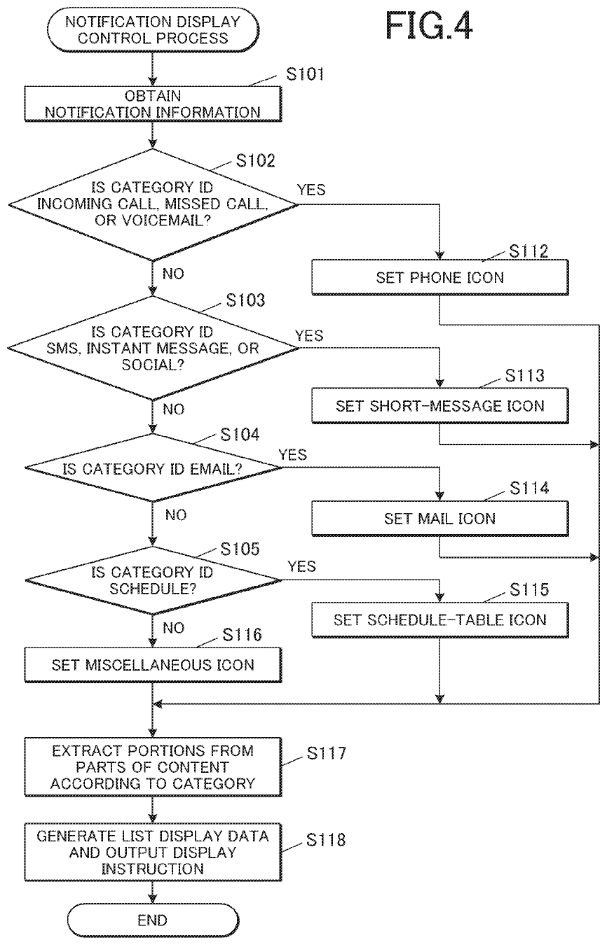

FIG. 4 is a flowchart showing control procedure of a notification display control process performed by the CPU 41 in this embodiment.

The notification display control process includes a notification control method in this embodiment, and starts when new notification information is obtained. When the notification display control process starts, the CPU 41 obtains new notification information as a display target from the memory 42 (Step S101). The CPU 41 determines whether or not a category ID specified in the notification information is “Incoming Call”, “Missed Call”, or “Voice Mail” (Step S102). If the CPU 41 determines that the category ID is “Incoming Call”, “Missed Call”, or “Voice Mail” (Step S102: YES), the CPU 41 refers to the icon setting information 424 and sets, to the notification information, the phone icon I4 (Step S112). The CPU 41 then proceeds to Step S117.

If the CPU 41 determines in Step S102 that the category ID is none of “Incoming Call”, “Missed Call”, or “Voice Mail” (Step S102: NO), the CPU 41 determines whether or not the category ID is “SMS”, “Instant Message”, or “Social” (Step S103). If the CPU 41 determines that the category ID is “SMS”, “Instant Message”, or “Social” (Step S103: YES), the CPU 41 refers to the icon setting information 424 and sets, to the notification information (information on reception of messages or the like through communications), the icon I1 relating to short messages (Step S113). The CPU 41 then proceeds to Step S117.

If the CPU 41 determines in Step S103 that the category ID is none of “SMS”, “Instant Message”, or “Social” (Step S103: NO), the CPU 41 determines whether or not the category ID is “Email” (Step S104). If the CPU 41 determines that the category ID is “Email” (Step S104: YES), the CPU 41 refers to the icon setting information 424 and sets, to the notification information, the mail icon I3 (Step S114). The CPU 41 then proceeds to Step S117.

If the CPU 41 determines that the category ID is not “Email” (Step S104: NO), the CPU 41 determines whether or not the category ID is “Schedule” (Step S105). If the CPU 41 determines that the category ID is “Schedule” (Step S105: YES), the CPU 41 refers to the icon setting information 424 and sets, to the notification information, the schedule-table icon I5 (Step S115). The CPU 41 then proceeds to Step S117.

If the CPU 41 determines that the category ID is not “Schedule” (Step S105: NO), the CPU 41 refers to the icon setting information 424 and sets, to the notification information, the miscellaneous icon I2 (Step S116). The CPU 41 then proceeds to Step S117.

After proceeding to Step S117 from any of Steps S112 to S116, the CPU 41 sets, according to the category ID, first and second parts as an extraction target in the content received, and extracts a predetermined number of characters from each of the first and second parts (Step S117). The CPU 41 arranges notification information for which an icon has been set and characters have been extracted previously and the newly obtained notification information, generates list display data, and outputs, to the display 52, a display instruction on the basis of the list display data (Step S118: notifying). The CPU 41 then ends the notification display control process.

As described above, the electronic timepiece 1 in this embodiment includes the display 52 that performs digital display, the communicator 53 that communicates with an external device such as a smartphone, and the CPU 41. The CPU 41 causes the display 52 to display, as multiple kinds of information obtained by the communicator 53 from the external device, an icon corresponding to a category to which each of the multiple kinds of information belongs.

The electronic timepiece 1 thus uses icons corresponding to the categories, instead of preparing icons corresponding to respective individual services such as applications. Hence, the electronic timepiece 1 does not have to obtain icons corresponding to respective services newly launched. Even if the electronic timepiece 1 cannot extract and display correct application names or the like on the basis of the contents not pursuant to standards, the electronic timepiece 1 can give a user a rough idea on what kind of information the notification is for. Thus, the user can easily obtain minimum necessary information for applications and services that the user uses. The display amount except the icons is particularly limited in displaying the list of notification information. With the icons appropriately associated with the categories, the electronic timepiece 1 can easily classify the contents of services that are difficult to classify without icons displayed and show the classified contents to the user.

Furthermore, each of the multiple kinds of information obtained by the communicator 53 includes information on the category. That is, the electronic timepiece 1 does not have to increase the amount of communication as compared with conventional electronic timepieces or obtain new information by controlling communication in order to determine icons. This restrains increase of time and efforts on processing.

Furthermore, the categories include information related to reception of messages through communications, the messages including SNS messages and instant messages. With respect to phone calls and emails, which usually follow common standards, phone numbers/email addresses are easily obtained to identify the callers/senders. With respect to SNS and the like, however, new services are frequently launched, and various data formats are used. This makes it difficult to identify the respective services and senders. Further, it requires time and efforts to obtain and display icon data corresponding to the respective services. The electronic timepiece 1 can obtain the effect of achieving both of restraining increase of time and efforts due to the above-described processing and displaying reliable and necessary information.

Furthermore, the icons include a miscellaneous icon indicating miscellaneous categories that are different from icon-set categories to each of which a set icon as a display target is set, and in response to obtaining notification information that does not belong to the icon-set categories, the CPU 41 causes the display 52 to display the miscellaneous icon. That is, the categories not often used or the like can be altogether labeled as miscellaneous. There are currently plenty of spare bits for the category IDs, and various categories may be added in the future. The electronic timepiece 1 can display icons minimally corresponding to these categories to be newly added.

Furthermore, the electronic timepiece 1 further includes the memory 42 that stores, as the icon setting information 424, data in which the categories are associated with the icons. On the basis of a setting instruction obtained from outside, the CPU 41 refers to the icon setting information 424 and sets, as the display target, each of the icons associated with the categories as the display target. Thus, the electronic timepiece 1 can easily select and display an icon for the category ID as the display target. Categories that are normally not often used may be excluded from the display target and labeled as miscellaneous. The correspondence between the categories and the icons can be flexibly adjusted according to the user's usage of the icons/categories, so as to be easily seen by the user.

Furthermore, in displaying a list of the multiple kinds of information, the CPU 41 extracts a portion of a content of each of the multiple kinds of information and causes the display 52 to display the portion and the icon. The portion of the content is extracted from a part that is determined for each of the categories. Information that tends to be required in displaying the list of notification information may vary depending on the content of the information. The format of communication data may also vary depending on services. By extracting appropriate portions for the respective categories, the electronic timepiece 1 can display meaningful contents in the list for the user.

Furthermore, the CPU 41 causes the display 52 to display, in displaying the list of the multiple kinds of information, the portion and the icon next to each other, the portion being extracted from a content of each of the multiple kinds of information and the icon corresponding to each of the categories to which each of the multiple kinds of information belongs. This clarifies the correspondence between the categories and the icons.

Furthermore, the notification control method in this embodiment includes notifying that is causing the display 52 to display, in displaying by the display 52 of a list of multiple kinds of information obtained by the communicator from the external device, an icon corresponding to a category to which each of the multiple kinds of information belongs.

According to the above-described notification control, the electronic timepiece 1 does not have to obtain and set icons corresponding to respective newly-launched services. Even if the electronic timepiece 1 cannot extract and display correct application names or the like on the basis of the contents not pursuant to standards, the electronic timepiece 1 can give the user a rough idea on what kind of information the notification is for. Thus, the user can obtain minimum necessary information for applications and services that the user uses.

The present invention is not limited to the above embodiment and can be variously modified.

For example, although in the above embodiment the electronic timepiece 1 obtains the notification information from a smartphone as an external device, this is not the limitation. The electronic timepiece 1 may obtain the notification information from other external devices such as tablets.

Furthermore, the above embodiment specifies a case where an icon is displayed at the top of each item in the list of notification information. However, the icon may also be displayed at the top of the detailed content of the item having been selected from the list. Further, the position of the icon is not limited to the top of the item/detailed content. The icon may be displayed at the end of the item and the upper right end of the detailed content.

Furthermore, the electronic timepiece 1 in the above embodiment uses BLE communication that includes category IDs, and identifies the categories on the basis of the communication to display notification information. However, the electronic timepiece 1 may perform communication through other communication standards. When the contents of the communication do not include category IDs or the like, categories may be set and sent independently. In such a case, icons for the categories may be set appropriately on the basis of the setting of the categories.

Further, the miscellaneous icon may not be necessary. Every category ID may be associated with any of the icons other than the miscellaneous icon. Alternatively, a multiple-use icon that does not directly indicate “miscellaneous”, such as an information icon, may be prepared, and all the categories labeled as miscellaneous may be associated with the multiple-use icon.

Furthermore, the correspondence between the icons and the categories may not be changeable but may be fixed to a preset correspondence.

Furthermore, the icons may not be figures having distinctive shapes, but may be characters/words, numbers, symbols, patterns, or a combination of them, as long as they are easily distinguishable by the user.

Furthermore, the content displayed together with an icon may not be extracted from two parts being the first and second parts as described above. The content may be extracted from one part, or from three or more parts depending on the number of characters. The number of parts from which portions are extracted may depend on the categories. For example, the schedule setting alone may have one extracted portion according to the content of setting. The electronic timepiece 1 may not display a content when the content includes nothing to be displayed, or may be configured to display the icons and the obtained time only. Part of or all of the part(s) from which a portion is extracted may not be individually determined for each of the categories.

Furthermore, although the icons are displayed digitally in the above embodiment, as with the digital display, an analog display that selects and displays icons on a rotating disk can display necessary information without additional new icons.

The detailed configuration, display contents, processes, and processing orders shown in the above embodiment(s) may be appropriately modified within the scope of the present invention.

Although some embodiments of the present invention have been described and illustrated in detail, the present invention is not limited to the embodiments described above but includes the scope of the present invention described in the scope of claims and the scope of their equivalents.

What is claimed is:

1. An electronic timepiece comprising:
a display;
a communicator that communicates with an external device; and
a processor that causes the display to display, as multiple kinds of information obtained by the communicator from the external device, an icon corresponding to a category to which each of the multiple kinds of information belongs.

2. The electronic timepiece according to claim 1, wherein each of the multiple kinds of information obtained by the communicator includes information on the category.

3. The electronic timepiece according to claim 1, wherein the category includes information related to reception of a message through a communication.

4. The electronic timepiece according to claim 2, wherein the category includes information related to reception of a message through a communication.

5. The electronic timepiece according to claim 1, wherein
the icon includes a miscellaneous icon indicating a miscellaneous category among the category, the miscellaneous category being different from an icon-set category among the category to which a set icon as a display target among the icon is set, and
in response to obtaining a kind of information among the multiple kinds of information that does not belong to the icon-set category, the processor causes the display to display the miscellaneous icon.

6. The electronic timepiece according to claim 2, wherein
the icon includes a miscellaneous icon indicating a miscellaneous category among the category, the miscellaneous category being different from an icon-set category among the category to which a set icon as a display target among the icon is set, and
in response to obtaining a kind of information among the multiple kinds of information that does not belong to the icon-set category, the processor causes the display to display the miscellaneous icon.

7. The electronic timepiece according to claim 3, wherein
the icon includes a miscellaneous icon indicating a miscellaneous category among the category, the miscellaneous category being different from an icon-set category among the category to which a set icon as a display target among the icon is set, and
in response to obtaining a kind of information among the multiple kinds of information that does not belong to the icon-set category, the processor causes the display to display the miscellaneous icon.

8. The electronic timepiece according to claim 4, wherein
the icon includes a miscellaneous icon indicating a miscellaneous category among the category, the miscellaneous category being different from an icon-set category among the category to which a set icon as a display target among the icon is set, and
in response to obtaining a kind of information among the multiple kinds of information that does not belong to the icon-set category, the processor causes the display to display the miscellaneous icon.

9. The electronic timepiece according to claim 5, further comprising a memory that stores data in which categories are associated with icons, each of the categories being the category and each of the icons being the icon, wherein
based on a predetermined setting instruction obtained from an outside, the processor refers to the data stored in the memory and sets, as the display target, each of the icons associated with the categories as the display target.

10. The electronic timepiece according to claim 6, further comprising a memory that stores data in which categories are associated with icons, each of the categories being the category and each of the icons being the icon, wherein
based on a predetermined setting instruction obtained from an outside, the processor refers to the data stored in the memory and sets, as the display target, each of the icons associated with the categories as the display target.

11. The electronic timepiece according to claim 7, wherein further comprising a memory that stores data in which categories are associated with icons, each of the categories being the category and each of the icons being the icon, wherein
based on a predetermined setting instruction obtained from an outside, the processor refers to the data stored in the memory and sets, as the display target, each of the icons associated with the categories as the display target.

12. The electronic timepiece according to claim 8, further comprising a memory that stores data in which categories are associated with icons, each of the categories being the category and each of the icons being the icon, wherein
based on a predetermined setting instruction obtained from an outside, the processor refers to the data stored in the memory and sets, as the display target, each of the icons associated with the categories as the display target.

13. The electronic timepiece according to claim 1, wherein
in displaying a list of the multiple kinds of information, the processor extracts a portion of a content of each of the multiple kinds of information and causes the display to display the portion and the icon, and
the portion of the content is extracted from a part that is determined for each of the category.

14. The electronic timepiece according to claim 2, wherein
in displaying a list of the multiple kinds of information, the processor extracts a portion of a content of each of the multiple kinds of information and causes the display to display the portion and the icon, and
the portion of the content is extracted from a part that is determined for each of the category.

15. The electronic timepiece according to claim 3, wherein
in displaying a list of the multiple kinds of information, the processor extracts a portion of a content of each of the multiple kinds of information and causes the display to display the portion and the icon, and
the portion of the content is extracted from a part that is determined for each of the category.

16. The electronic timepiece according to claim 4, wherein
in displaying a list of the multiple kinds of information, the processor extracts a portion of a content of each of the multiple kinds of information and causes the display to display the portion and the icon, and
the portion of the content is extracted from a part that is determined for each of the category.

17. The electronic timepiece according to claim 5, wherein
in displaying a list of the multiple kinds of information, the processor extracts a portion of a content of each of the multiple kinds of information and causes the display to display the portion and the icon, and
the portion of the content is extracted from a part that is determined for each of the category.

18. The electronic timepiece according to claim 6, wherein
in displaying a list of the multiple kinds of information, the processor extracts a portion of a content of each of the multiple kinds of information and causes the display to display the portion and the icon, and
the portion of the content is extracted from a part that is determined for each of the category.

19. The electronic timepiece according to claim 1, wherein the processor causes the display to display, in displaying a list of the multiple kinds of information, a portion and the icon next to each other, the portion being extracted from a content of each of the multiple kinds of information and the icon corresponding to each of the multiple kinds of information.

20. A notification control method for an electronic timepiece including a display and a communicator that communicates with an external device, the notification control method comprising:
notifying that is causing the display to display, as multiple kinds of information obtained by the communicator from the external device, an icon corresponding to a category to which each of the multiple kinds of information belongs.
